(19) United States
(12) Patent Application Publication
(10) Pub. No.: US 2014/0313709 A1
(43) Pub. Date: Oct. 23, 2014

(54) FLASHLIGHT

(71) Applicant: KLARUS LIGHT TECHNOLOGY CO., LTD., Shenzhen City (CN)

(72) Inventor: Qi Yuan, Shenzhen City (CN)

(73) Assignee: Klarus Light Technology Co., Ltd., Shenzhen City (CN)

(21) Appl. No.: 13/866,463

(22) Filed: Apr. 19, 2013

(51) Int. Cl. F21V 23/04

(52) U.S. Cl. CPC F21V 23/0421
USPC 362/202

(57) ABSTRACT

The present invention provides a flashlight, including an LED lamp holder, a battery compartment and a tail coupled sequentially, LED lamps arranged inside the LED lamp holder, batteries arranged inside the battery compartment, wherein the tail includes a button rubber cap and a control circuit board used to adjust the brightness of the LED lamps, a plurality of touch control devices jointed with the button rubber cap is disposed between the a button rubber cap and the control circuit board. The control circuit board includes a control circuit, a voltage supply circuit to provide stable voltage for the control circuit and a switch circuit, the technical solution of the present invention solve the problem that the existing flashlight is single manipulation, avoid affecting the normal lighting because of cyclic manipulation the lighting gears, meanwhile solve the problem that the tail switch is easy to be damaged due to large current.

### TECHNICAL FIELD

The present invention relates to a lighting circuit, and more particularly, to a flashlight.

### BACKGROUND

The common circular flashlight on the market generally has a single mechanical switch, if need multifunctional manipulation, users have to do cycle operation with the switch, because the switch can not be controlled independently or controlled multifunctionally, further, such design will bring users unclear operation control, so that it can not meet the demand of multifunction and point-to-point manipulation, which enables users can not find lighting gears what they need quickly and accurately, when they use the flashlight.

In addition, a non-circular flashlight with manipulation switch appears on the market, the non-circular flashlight includes at least two parallel switches, which meet the demand of multifunction and point-to-point manipulation, but in carrying aspects, the non-circular flashlight changes the size of the traditional flashlight, which is not ideal for convenience and comfortable in use.

### SUMMARY

A technical problem solved by the present invention is to solve the defects of existing flashlight is either single manipulation or inconvenient to use, and provide a manipulation which is easy to use and multifunctional manipulation.

The technical solution adopted by the present invention to solve technical problems is: a flashlight includes an LED lamp holder, a battery compartment and a tail coupled sequentially. LED lamps are arranged inside the LED lamp holder, batteries are arranged inside the battery compartment, wherein, the tail includes a button rubber cap and a control circuit board used to adjust the brightness of the LED lamps, a plurality of touch control devices jointed with the button rubber cap is disposed between the button rubber cap and the control circuit board, the control circuit board includes a control circuit, a voltage supply circuit to provide stable voltage for the control circuit and a switch circuit, the on-off of the switch circuit is controlled by triggering the touch control devices, and the brightness of the LED lamps is adjusted according to PWM signals output by the control circuit.

In the flashlight of present invention, the touch control devices include a switch, an optical sensing device, a temperature sensing device and a magnetic induction device therein.

In the flashlight of present invention, the number of the touch control device is two.

In the flashlight of present invention, the voltage supply circuit includes a chip IC1, a diode D1, a capacitor C1 and a capacitor C2 therein,_the pin VIN of the chip IC1 is coupled to the cathode of a battery, the pin VOUT of the chip IC1 is coupled to the anode of the diode D1, the cathode of the diode D1 are respectively coupled to one end of the capacitor C1, one end of the capacitor C2 and a 3V voltage, the other end of the capacitor C1 and the other end of the capacitor C1 are respectively coupled to the ground.

In the flashlight of present invention, the control circuit includes a chip IC2, a switch S1 and a switch S2, therein, the pin VCC of the chip IC2 is coupled to the 3V voltage, the pin GP0 of the chip IC2 is coupled to one end of the switch S2, the other end of the switch S2 is coupled to the ground, the pin GP1 of the chip IC2 is coupled to one end of the switch S1, the other end of the switch S1 is coupled to the ground.

In the flashlight of present invention, the switch circuit includes a switch tube Q1, the grid electrode of the switch tube Q1 is coupled to the pin GP2 of the chip IC2, the drain electrode of the switch tube is coupled to the negative electrode of the battery, and the source electrode of the switch tube Q1 is coupled to grounded.

In the flashlight of present invention, the chip IC2 is a central processor.

In the flashlight of present invention, the flashlight is circular.

Comparing with the prior arts, the beneficial effects of the present invention are described as follow: the on-off of the switch circuit is controlled by triggering the touch control devices, and the brightness of the LED lamps is adjusted according to PWM signals output by the control circuit, the technical solution of the present invention solve the problem that the existing flashlight is single manipulation, avoid affecting the normal lighting because of cyclic manipulation the lighting gears, meanwhile solve the problem that the tail switch is easy to be damaged due to large current which affects the normal life and use of the flashlight, and further realize the multifunctional manipulation.

### BRIEF DESCRIPTION OF THE DRAWINGS

The present invention will be described in detail with reference to the drawings and the examples, wherein:

FIG. 1 is a partially sectional view of a flashlight in accordance with an embodiment of the present invention;

FIG. 2 is a structural view of a switch in accordance with the embodiment of the invention;

FIG. 3 is a circuit diagram of the flashlight in accordance with the embodiment of the invention.

### DETAILED DESCRIPTION OF THE PREFERRED EMBODIMENTS

Objects, advantages and embodiments of the present invention will be explained below in detail with reference to the accompanying drawings and embodiments. However, it should be appreciated that the following description of the embodiment is merely exemplary in nature and is not intended to limit this invention.

It should be explained that, the flashlight includes an LED lamp holder, a battery compartment and a tail coupled sequentially, LED lamps are arranged inside the LED lamp holder, and batteries are arranged inside the battery compartment.

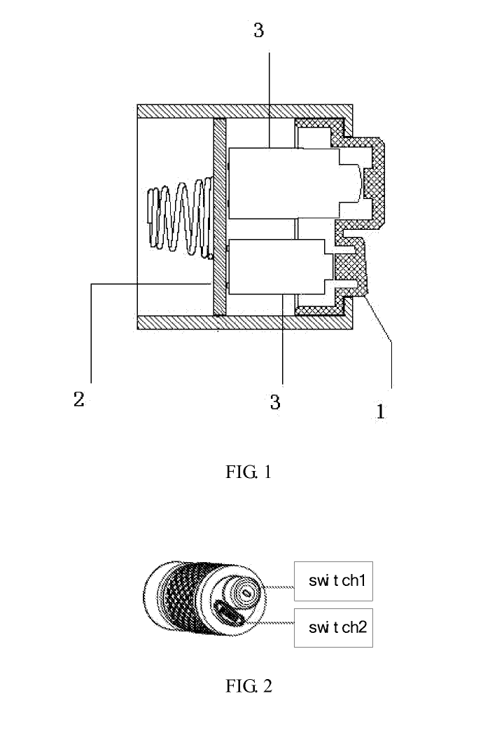

Referring to FIG. 1, FIG. 1 is a partially sectional view of a flashlight in accordance with the embodiment of the invention, as shown in FIG. 1, the tail includes a button rubber cap 1 and a control circuit board 2 used to adjust the brightness of the LED lamps, a plurality of touch control devices 3 jointed with the button rubber cap 1 is disposed between the button rubber cap 1 and the control circuit board 2.

The touch control device 3 includes a switch, an optical sensing device, a temperature sensing device and a magnetic induction device therein, the touch control device 3 is a switch, the number of the touch control device 3 is two, referring to FIG. 2, FIG. 2 is a structural view of a switch in accordance with the embodiment of the invention, As shown in FIG. 2, in other embodiments, in order to meet the multifunctional manipulation of a product, the skilled in the art should know that, the number of switch or other touch control devices can be increased, here will not repeat.

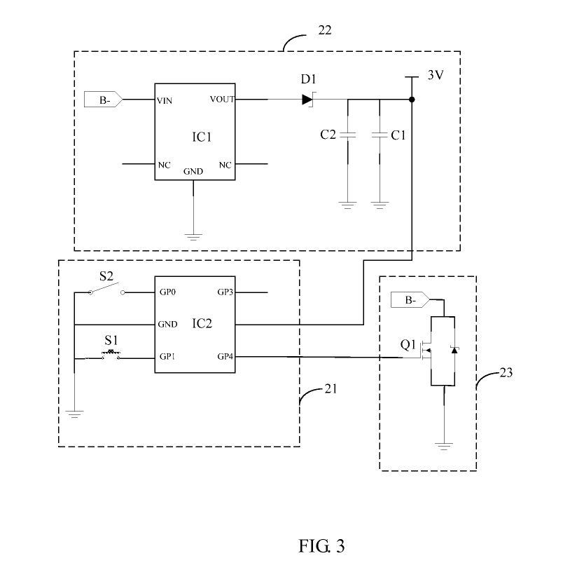

Referring to FIG. 3, FIG. 3 is a circuit diagram of the flashlight in accordance with the embodiment of the invention, As shown in FIG. 3, the control circuit board 2 includes a control circuit 21, a voltage supply circuit 22 to provide stable voltage for the control circuit 21 and a switch circuit 23, the on-off of the switch circuit 23 is controlled by triggering the touch control devices 3, and the brightness of the LED lamps is adjusted according to PWM signals output by the control circuit 21, the instructions of each part will be described as follow:

The voltage supply circuit 22 includes a chip IC1, a diode D1, a capacitor C1 and a capacitor C2 therein, the pin VIN of the chip IC1 is coupled to the cathode of a battery, the pin VOUT of the chip IC1 is coupled to the anode of the diode D1, the cathode of the diode D1 are respectively coupled to one end of the capacitor C1, one end of the capacitor C2 and a 3V voltage, the other end of the capacitor C1 and the other end of the capacitor C1 are respectively coupled to the ground. In the present embodiment, the diode D1 is the breakdown diode.

The control circuit 21 includes a chip IC2, a switch S1 and a switch S2 therein, the pin VCC of the chip IC2 is coupled to the 3V voltage, the pin GPO of the chip IC2 is coupled to one end of the switch S2, the other end of the switch S2 is coupled to the ground, the pin GP1 of the chip IC2 is coupled to one end of the switch S1, the other end of the switch S1 is coupled to the ground. In the present embodiment, the chip IC2 is a central processor. The switch S1 is a main switch, the switch S2 is a vice switch, it is worth mentioning that, the skilled in the art should know that, the pin of the chip IC2 pin can be customized according to the needs of users, here will not repeat.

The switch circuit 23 includes a switch tube Q1, the grid electrode of the switch tube Q1 is coupled to the pin GP2 of the chip IC2, the drain electrode of the switch tube is coupled to the negative electrode of the battery, the source electrode of the switch tube Q1 is coupled to the ground. It should be noted that, in the present embodiment, when the pin GP2 of the chip IC2 GP2 output high, the switch Q1 is conducted, when the pin GP2 of the chip IC2 GP2 output low, switch Q1 is cut off, the skilled in the art should know that, here will not repeat.

Preferably, the flashlight is circular.

Comparing with the prior arts, the on-off of the switch circuit is controlled by triggering the touch control devices, and the brightness of the LED lamps is adjusted according to PWM signals output by the control circuit, the technical solution of the present invention solve the problem that the existing flashlight is single manipulation, avoid affecting the normal lighting because of cyclic manipulation the lighting gears, meanwhile solve the problem that the tail switch is easy to be damaged due to large current which affects the normal life and use of the flashlight, and further realize the multifunctional manipulation.

The embodiments above are merely the preferable embodiments of the present invention and not intended to limit the present invention. And all changes, equivalent substitution and improvements which come within the meaning and range of equivalency of the present invention are intended to be embraced therein.

What is claimed is:

1. A flashlight comprising:
an LED lamp holder,
a battery compartment and a tail coupled sequentially,
LED lamps arranged inside the LED lamp holder, and
batteries arranged inside the battery compartment,
wherein the tail comprises a button rubber cap (1) and a control circuit board (2) used to adjust the brightness of the LED lamps, a plurality of touch control devices (3) jointed with the button rubber cap (1) is disposed between the button rubber cap (1) and the control circuit board (2), the control circuit board (2) comprises a control circuit (21), a voltage supply circuit (22) to provide stable voltage for the control circuit (21) and a switch circuit (23), the on-off of the switch circuit (23) is controlled by triggering the touch control devices (3), and the brightness of the LED lamps is adjusted according to PWM signals output by the control circuit (21).

2. The flashlight as claimed in claim 1, wherein the touch control devices (3) comprise a switch, an optical sensing device, a temperature sensing device and a magnetic induction device therein.

3. The flashlight as claimed in claim 2, wherein the number of the touch control device (3) is two.

4. The flashlight as claimed in claim 3, wherein the voltage supply circuit (22) comprises a chip IC1, a diode D1, a capacitor C1 and a capacitor C2 therein, the pin VIN of the chip IC1 is coupled to the cathode of a battery, the pin VOUT of the chip IC1 is coupled to the anode of the diode D1, the cathode of the diode D1 are respectively coupled to one end of the capacitor C1, one end of the capacitor C2 and a 3V voltage, the other end of the capacitor C1 and the other end of the capacitor C1 are respectively coupled to the ground.

5. The flashlight as claimed in claim 4, wherein the control circuit (21) comprises a chip IC2, a switch S1 and a switch S2 therein, the pin VCC of the chip IC2 is coupled to the 3V voltage, the pin GPO of the chip IC2 is coupled to one end of the switch S2, the other end of the switch S2 is coupled to the ground, the pin GP1 of the chip IC2 is coupled to one end of the switch S1, the other end of the switch S1 is coupled to the ground.

6. The flashlight as claimed in claim 5, wherein the switch circuit (23) comprises a switch tube Q1, the grid electrode of the switch tube Q1 is coupled to the pin GP2 of the chip IC2, the drain electrode of the switch tube is coupled to the negative electrode of the battery, and the source electrode of the switch tube Q1 is coupled to grounded.

7. The flashlight as claimed in claim 6, wherein the chip IC2 is a central processor.

8. The flashlight as claimed in claim 1, wherein the flashlight is circular.
